(19) United States
(12) Patent Application Publication
(10) Pub. No.: US 2013/0042486 A1
(43) Pub. Date: Feb. 21, 2013

(54) GARDENING SHEARS

(71) Applicant: Mike C. Lee, Taipei City (TW)

(72) Inventor: Mike C. Lee, Taipei City (TW)

(73) Assignee: Duracraft Products Co., Ltd., Taipei City (TW)

(21) Appl. No.: 13/213,040

(22) Filed: Aug. 18, 2011

(51) Int. Cl. A01G 3/02

(52) U.S. Cl. 30/249

(57) ABSTRACT

A garden shears includes a connecting member having a pivoting section and an engaging section, the pivoting section having a shaft aperture and a securing aperture, the securing aperture accepting a limiting member, and the engaging section having a chamber connected to the securing aperture; a blade assembled with the shaft aperture and pivoted with a passive gear; a rotatable handle having an axis rod inserted into the chamber, the axis rod pivoted onto the limiting member, a first toothed element disposed between the axis rod and the rotatable handle, and the first toothed element engaging with the passive gear; and an anvil handle having a shaft locked onto the shaft aperture; the anvil further having a second toothed element, the second toothed element engaging with the passive gear. When the second toothed element drives the passive gear, the passive gear drives the first toothed element to rotate the rotatable handle.

### BACKGROUND OF THE INVENTION

1. Field of the Invention

The present invention relates to a gardening shears, and more particularly to gardening shears providing smooth cutting movements.

2. Description of the Related Art

Currently, shears provide convenient cutting mechanism, which is commonly used in gardening activities. Usually, the shears are used for cutting large branches; therefore, the common design is to combine a blade and an anvil together. However, typical gardening shears have rigid handles, when a user holds the handles of the shears, his or her palm continuously rubs against the handle during the cutting process, which interferes with the strength transferring from the hand to the shears and causes discomfort to the user's hand.

Therefore, it is desirable to provide a gardening shears to mitigate and/or obviate the aforementioned problems.

### SUMMARY OF THE INVENTION

An objective of the present invention is to provide a gardening shears.

In order to achieve the above-mentioned objectives, gardening shears comprises a connecting member, a blade, a rotatable handle and an anvil handle. The connecting member has a pivoting section and an engaging section, the pivoting section has a shaft aperture at a center position and a securing aperture adjacent to the shaft aperture, the securing aperture accepts a limiting member, and the engaging section has a chamber connected to the securing aperture. The blade has a through hole assembled with the shaft aperture of the pivoting section and a pivoting aperture at an end towards the engaging section, and the pivoting aperture is pivoted with a passive gear. The rotatable handle has an axis rod inserted into the chamber of the connecting member, the axis rod pivoted onto the limiting member, a first toothed element is disposed between the axis rod and the rotatable handle, and the first toothed element engaging with the passive gear of the blade. The anvil handle has an anvil and a through aperture disposed on the anvil, the through aperture is used for accepting a shaft, the shaft passes through the pivoting aperture and locked onto the shaft aperture of the connecting member such that the blade and the anvil are capable of overlapping with each other, the anvil further has a second toothed element, the second toothed element engages with the passive gear, wherein when the blade and the anvil are overlapping with each other, the second toothed element drives the passive gear, and the passive gear drives the first toothed element to rotate the rotatable handle.

The anvil handle rotates the passive gear via the second toothed element, the passive gear drives the first toothed element of the rotatable handle, such that the first toothed element makes the rotatable handle to rotate around the axis rod and along the limiting member. The self-rotation of the rotatable handle is equal to the handle rotation angle created the user's hand, during the cutting process, which eliminates the interference of the strength transferring from the hand to the shears and the discomfort to the user's hand.

Other objects, advantages, and novel features of the invention will become more apparent from the following detailed description when taken in conjunction with the accompanying drawings.

### BRIEF DESCRIPTION OF THE DRAWINGS

FIG. 1 is a perspective drawing of an embodiment of the present invention.

FIG. 2 is a perspective exploded drawing of the embodiment of the present invention.

FIG. 3 is a schematic drawing of the limiting member and the axis rod being connected together according to the present invention.

FIG. 4 is a schematic drawing of cutting movements according to the present invention.

FIG. 5 is another schematic drawing of cutting movements according to the present invention.

### DETAILED DESCRIPTION OF THE PREFERRED EMBODIMENT

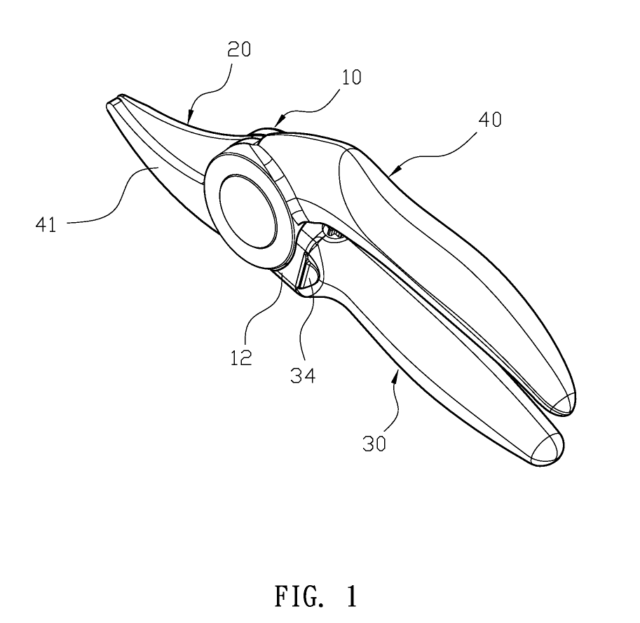

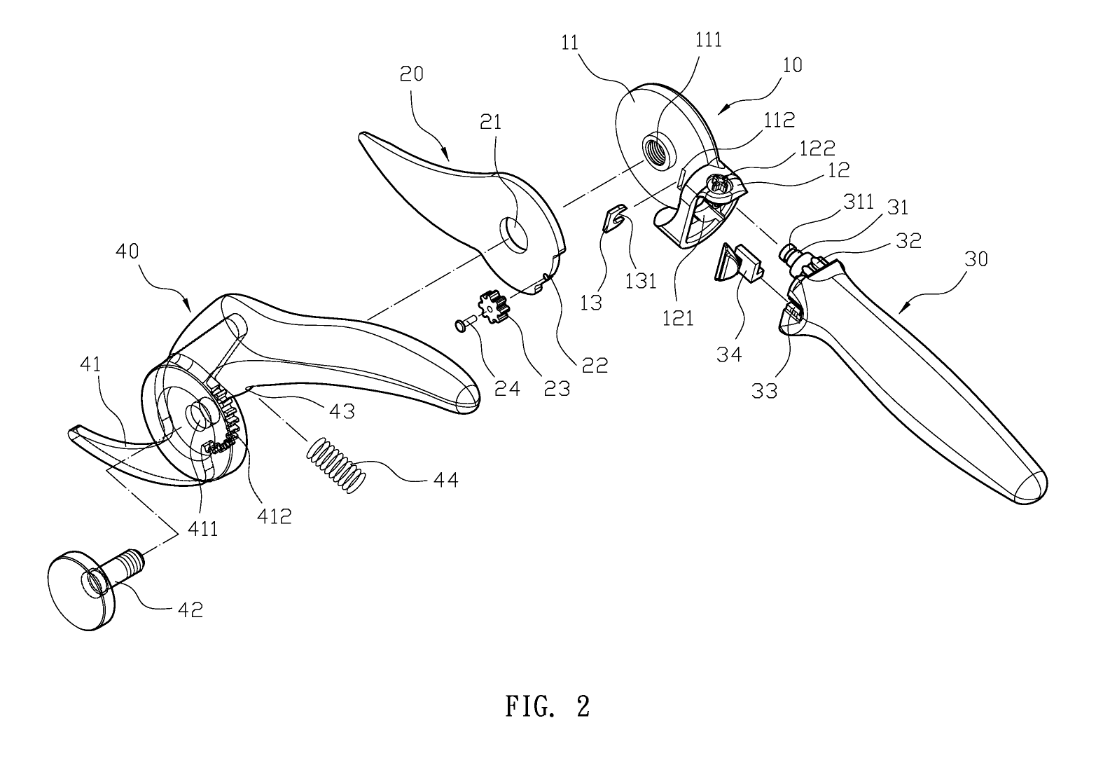

Please refer to FIG. 1 and FIG. 2. Gardening shears comprises a connecting member 10, a blade 20, a rotatable handle 30 and an anvil handle 40. The connecting member 10 has a pivoting section 11 and an engaging section 12, the pivoting section 11 has a shaft aperture 111 at a center position and a securing aperture 112 adjacent to the shaft aperture 111, the securing aperture 112 accepts a limiting member 13, and the engaging section 12 has a chamber 121 connected to the securing aperture 112. The limiting member 13 of the connecting member 10 further has a C-shaped slot, an opening of the C shaped slot faces towards the chamber 121. The blade 20 has a through hole 21 assembled with the shaft aperture 111 of the pivoting section 11 and a pivoting aperture 22 at an end towards the engaging section 12, and the pivoting aperture 22 is pivoted with a passive gear 23. A pivoting rod 24 is placed through the passive gear 23, and the passive gear 23 is riveted to the pivoting rod 24 via the pivoting aperture 33. The rotatable handle 30 has an axis rod 31 inserted into the chamber 121 of the connecting member 10, and the axis rod 31 is pivoted onto the limiting member 13. The rotatable handle 30 further has a ring slot 311 disposed around the axis rod 31, and the ring slot 311 of the axis rod 31 is inserted with the C-shaped slot 131 of the limiting member 13 such that the axis rod 31 is able to rotate along the C shaped slot 131. A first toothed element 32 is disposed between the axis rod 31 and the rotatable handle 30, and the first toothed element 32 engages with the passive gear 23 of the blade 20. The first toothed element 32 includes a plurality of vertical parallel teeth, a free end of each tooth being triangular-shaped and corresponding to the passive gear 23. The rotatable handle 30 further has a sliding slot 33 adjacent to the first toothed element 32 and a positioning member 34 slibably mounted onto the sliding slot 33. When the positioning member 34 is pushed towards the passive gear 23, the positioning member 34 engages with the passive gear 23 to secure the rotatable handle 30 and the anvil handle 40 together. The anvil handle 40 has an anvil 41 and a through aperture 411 disposed on the anvil 41, the through aperture 411 is used for accepting a shaft 42, the shaft 42 passes through the through hole 21 and locked onto the shaft aperture 111 of the connecting member 10 such that the blade 20 and the anvil 41 are capable of overlapping with each other. The anvil 41 further has a second toothed element 412, and the second toothed element 412 engages with the passive gear 23. The connecting member 10 further has a securing portion 122 at the engaging section 12, the anvil handle 40 has an assembling portion 43 corresponding to the securing portion 122, and an elastic member 44 is connected between the assembling portion 43 of the anvil handle 40 and the securing portion 122 of the connecting member 10. When the blade 20 and the anvil 41 are overlapping with each other, the second toothed element 412 drives the passive gear 23, and the passive gear 23 drives the first toothed element 32 to rotate the rotatable handle 30.

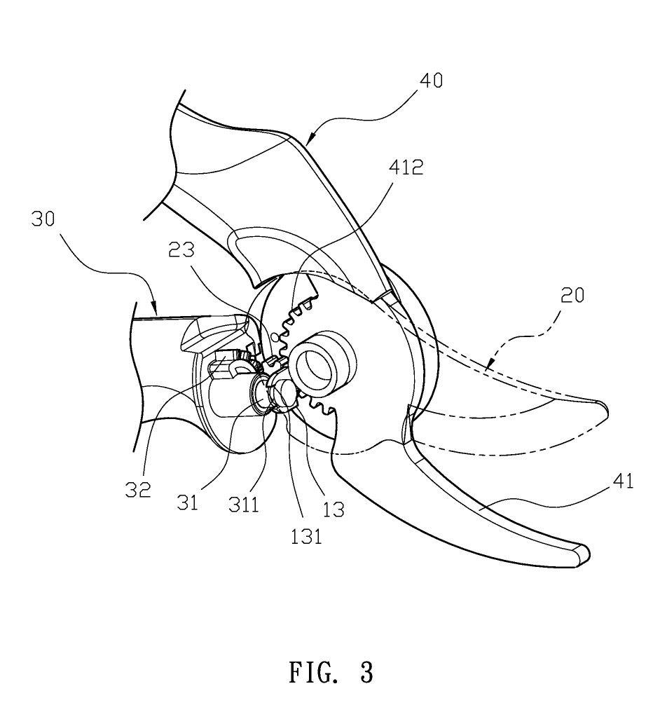

For actual assembly, please refer to FIG. 2 and FIG. 3. The rotatable handle 30 has the positioning member 34 sildably mounted onto the sliding slot 33, the axis rod 31 is placed through the chamber 121 of the connecting member 10, and the limiting member 13 is placed through the securing aperture 112 of the connecting member 10 to make the C shaped slot 131 of the limiting member 13 engages with the ring slot 311 of the axis rod 31 such that the rotatable handle 30 is rotatable limited in the engaging section 12 of the connecting member 10. The blade 20 is installed onto the pivoting section 11 of the connecting member 10, the through hole 21 is jacketed onto the shaft aperture 111, and the blade 20 is riveted with the passive gear 23 at the pivoting aperture 22 such that the passive gear 23 engages with the first toothed element 32 of the rotatable handle 30. Furthermore, the anvil handle 40 includes the anvil 41 formed by projection method, the shaft 42 is placed through the through aperture 411 of the anvil 41 and locked onto the shaft aperture 111 of the connecting member 10, to make the blade 20 and the anvil 41 pivot with each other. Moreover, the second toothed element 412 of the anvil 41 engages with the passive gear 23 of the blade 20, the passive gear 23 engages with and between the first toothed element 32 and the second toothed element 412, and the elastic member 44 is disposed between the securing portion 122 of the connecting member 10 and the assembling portion 43 of the anvil handle 40.

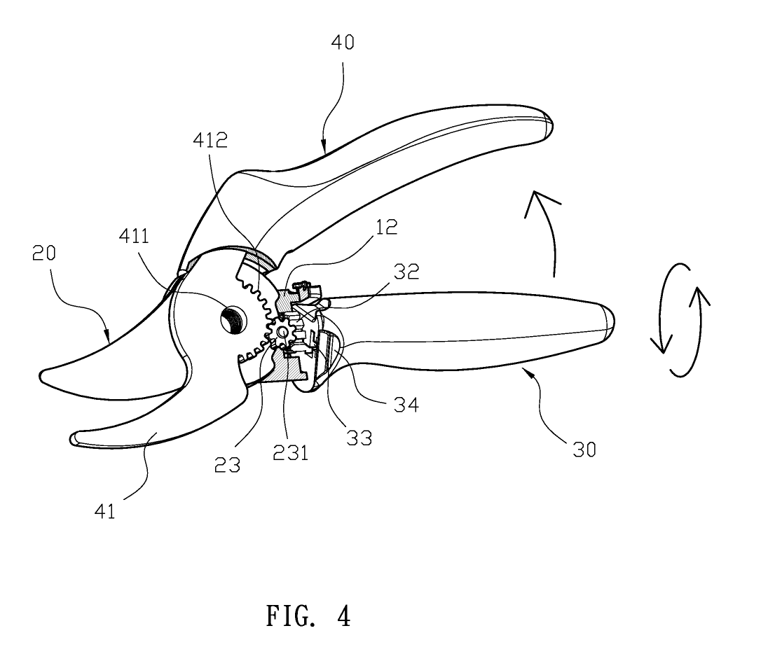

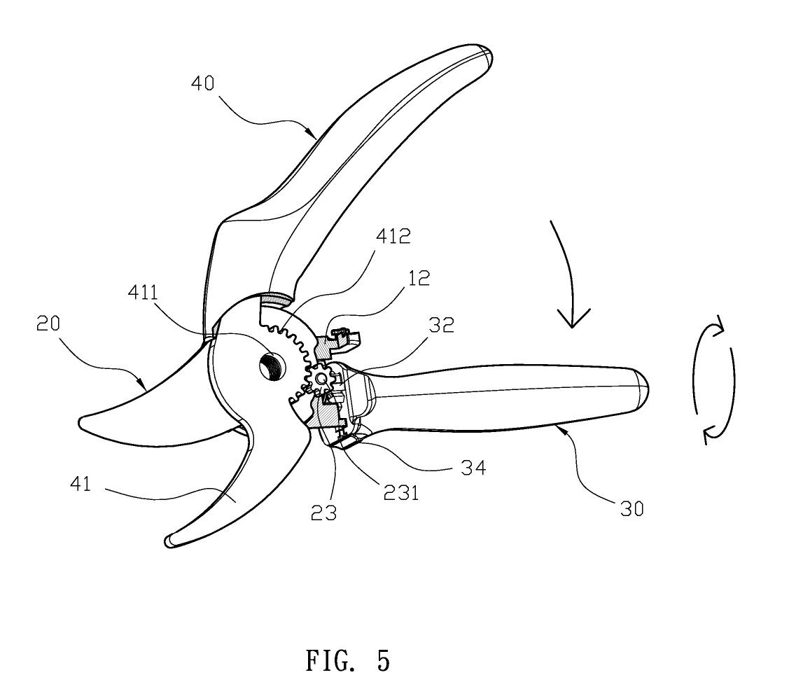

For actual use, please refer to FIG. 3, FIG. 4, FIG. 5 and FIG. 2. When the user presses down the rotatable handle 30, the rotatable handle 30 rotates around the shaft 42 to move closer to the anvil handle 40 such that the blade 20 attached onto the connecting member 10 moves towards to the anvil 41 to generate cutting movements. Meanwhile, the passive gear 23 connected to the blade 20 and the second toothed element 412 on the anvil 41 generate relative rotation, and the second toothed element 412 drives the passive gear 23. Since another end of the passive gear 23 engages with the first toothed element 32 of the rotatable handle 30, the first toothed element 32 is also driven by the passive gear 23, and the first toothed element 32 makes the axis rod 31 of the rotatable handle 30 rotates along the limiting member 13, and the self-rotation generated by the rotatable handle 30 is equal to the pressing angle provided by the hand of the user, which can eliminate the friction between the fingers of the user and the rotatable handle 30 and increase the smoothnes of the cutting movement. In addition, when the user releases his or her hand, the blade 20 and the anvil 41 are pushed by the elastic member 44 to return to the initial positions. Similarly, the second toothed element 412 on the anvil 41 drives the first toothed element 32 of the rotatable handle 30 via the passive gear 23 such that the rotatable handle 30 rotate reversely to return back to its initial position.

Although the present invention has been explained in relation to its preferred embodiment, it is to be understood that many other possible modifications and variations can be made without departing from the spirit and scope of the invention as hereinafter claimed.

What is claimed is:

1. A gardening shears comprising:
a connecting member having a pivoting section and an engaging section, the pivoting section having a shaft aperture at a center position and a securing aperture adjacent to the shaft aperture, the securing aperture accepting a limiting member, and the engaging section having a chamber connected to the securing aperture;
a blade having a through hole assembled with the shaft aperture of the pivoting section and a pivoting aperture at an end towards the engaging section, and the pivoting aperture pivoted with a passive gear;
a rotatable handle having an axis rod inserted into the chamber of the connecting member, the axis rod pivoted onto the limiting member, a first toothed element disposed between the axis rod and the rotatable handle, and the first toothed element engaging with the passive gear of the blade; and
an anvil handle having an anvil and a through aperture disposed on the anvil, the through aperture used for accepting a shaft, the shaft passing through the through hole and locked onto the shaft aperture of the connecting member such that the blade and the anvil are capable of overlapping with each other, the anvil further having a second toothed element, the second toothed element engaging with the passive gear, wherein when the blade and the anvil are overlapping with each other, the second toothed element drives the passive gear, and the passive gear drives the first toothed element to rotate the rotatable handle.

2. The garden shears as claimed in claim 1, wherein the rotatable handle further has a sliding slot adjacent to the first toothed element and a positioning member slibably mounted onto the sliding slot; wherein when the positioning member is pushed towards the passive gear, the positioning member engages with the passive gear to secure the rotatable handle and the anvil handle together.

3. The garden shears as claimed in claim 1, wherein the limiting member of the connecting member further has a C-shaped slot, an opening of the C shaped slot facing towards the chamber, the rotatable handle further having a ring slot disposed around the axis rod, and the ring slot of the axis rod is inserted with the C-shaped slot of the limiting member such that the axis rod is able to rotate along the C shaped slot.

4. The garden shears as claimed in claim 1, wherein a pivoting rod is placed through the passive gear, and the passive gear is riveted to the pivoting rod via the pivoting aperture.

5. The garden shears as claimed in claim 1, wherein the connecting member further has a securing portion at the engaging section, the anvil handle has an assembling portion corresponding to the securing portion, and an elastic member is connected between the assembling portion of the anvil handle and the securing portion of the connecting member.

6. The garden shears as claimed in claim 1, wherein the first toothed element includes a plurality of vertical parallel teeth, a free end of each tooth being triangular-shaped and corresponding to the passive gear.
